(19) United States
(12) Patent Application Publication
(10) Pub. No.: US 2017/0057776 A1
(43) Pub. Date: Mar. 2, 2017

(54) BOOKLET PROCESSING APPARATUS AND IMAGE FORMING SYSTEM

(71) Applicant: FUJI XEROX Co., Ltd., Tokyo (JP)

(72) Inventor: Yutaka NOBE, Kanagawa (JP)

(73) Assignee: FUJI XEROX Co., Ltd., Tokyo (JP)

(21) Appl. No.: 15/049,389

(22) Filed: Feb. 22, 2016

(30) Foreign Application Priority Data
Sep. 1, 2015 (JP) 2015-172311

(51) Int. Cl. B65H 45/18; B31F 5/00; B65H 45/16

(52) U.S. Cl. CPC B65H 45/18; B65H 45/162; B31F 5/005; B65H 2301/45

(57) ABSTRACT

A booklet processing apparatus includes a pressing member and a rotating unit. The pressing member presses a folded portion of a booklet formed to extend in one direction and having the folded portion on the downstream side in the one direction. The pressing member is provided so as to be rotatable about a rotary shaft that extends along the folded portion. The rotating unit rotates the pressing member so as to move a portion of the pressing member that confronts the folded portion downstream in the one direction so that the portion of the pressing member that confronts the folded portion is changed to a different portion.

### CROSS-REFERENCE TO RELATED APPLICATIONS

This application is based on and claims priority under 35 USC 119 from Japanese Patent Application No. 2015-172311 filed Sep. 1, 2015.

### BACKGROUND

### Technical Field

The present invention relates to a booklet processing apparatus and an image forming system.

### SUMMARY

According to an aspect of the present invention, there is provided a booklet processing apparatus including: a pressing member that presses a folded portion of a booklet formed to extend in one direction and having the folded portion on a downstream side in the one direction, the pressing member being provided so as to be rotatable about a rotary shaft that extends along the folded portion; and a rotating unit that rotates the pressing member so as to move a portion of the pressing member that confronts the folded portion downstream in the one direction so that the portion of the pressing member that confronts the folded portion is changed to a different portion.

### BRIEF DESCRIPTION OF THE DRAWINGS

An exemplary embodiment of the present invention will be described in detail based on the following figures, wherein:

FIG. 1 is an overall view of an image forming system;

FIG. 2 illustrates a post-processing apparatus;

FIG. 3 illustrates a center bookbinding function section;

FIG. 4 illustrates components around a folding processing mechanism;

FIG. 5 is a perspective view of a pressing roller portion;

FIG. 6 is a development view of the outer peripheral surface of a first pressing roller;

FIGS. 7A to 7D illustrate a pressing process performed by the pressing roller portion;

FIGS. 8A and 8B illustrate the details of the first pressing roller and a second pressing roller;

FIG. 9 illustrates another configuration example of the first pressing roller and the second pressing roller;

FIGS. 10A to 10D illustrate another operation example of the first pressing roller and the second pressing roller;

FIG. 11A to 11C illustrate operation of the first pressing roller and the second pressing roller in the case where the first pressing roller and the second pressing roller are rotated when the pressing rollers are retracted from and advanced toward a folded portion;

FIGS. 12A and 12B illustrate a reception-time separation amount;

FIGS. 13A and 13B illustrate the final stage of the pressing process performed by the first pressing roller and the second pressing roller;

FIG. 14 illustrates a configuration example of a mechanism that advances and retracts the second pressing roller toward and from the folded portion; and

FIG. 15 illustrates a state in which the second pressing roller has been advanced toward the folded portion.

### DETAILED DESCRIPTION

An exemplary embodiment of the present invention will be described in detail below with reference to the accompanying drawings.

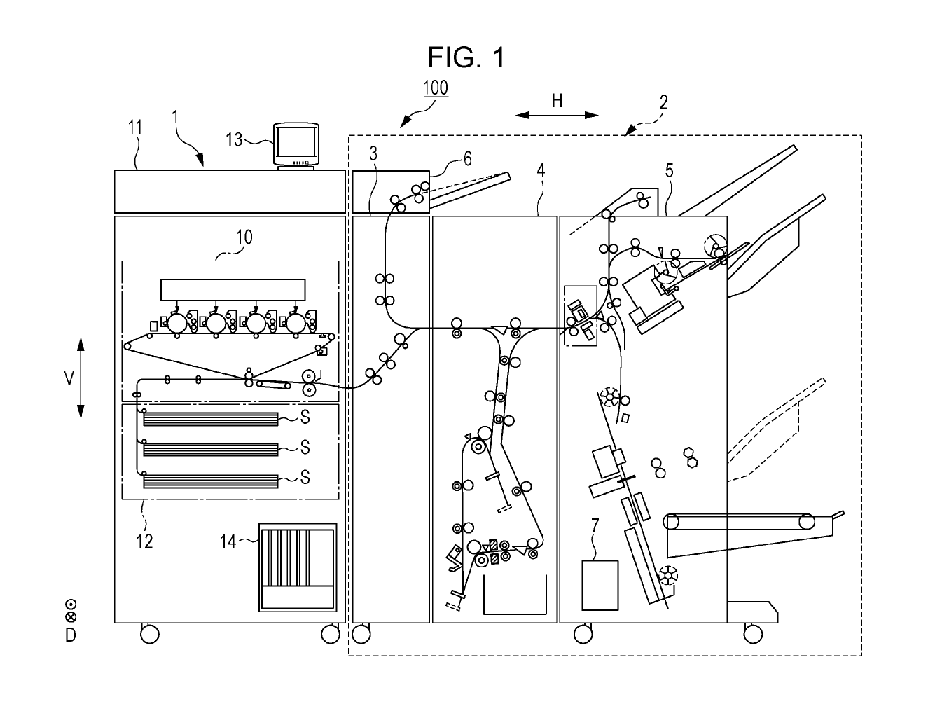

FIG. 1 is an overall view of an image forming system 100 according to an exemplary embodiment.

As illustrated in FIG. 1, the image forming system 100 is provided with an image forming apparatus 1 such as a printer and a copier that forms a color image using an electrophotographic method, for example, and a post-processing apparatus 2 that performs post-processing on paper S on which an image has been formed by the image forming apparatus 1.

In the description of the exemplary embodiment, the direction between the front side and the back side of the image forming system 100 illustrated in FIG. 1 with respect to the sheet surface is defined as a front-rear direction D. In addition, the direction between the upper side and the lower side of the image forming system 100 illustrated in FIG. 1 with respect to the sheet surface is defined as a vertical direction V. Further, the direction between the left side and the right side of the image forming system 100 with respect to the sheet surface is defined as a horizontal direction H.

The image forming apparatus 1 is provided with: an image forming section 10 that forms an image on the basis of image data for each color; an image reading section 11 that reads an image from a document to generate read image data; a paper supply section 12 that supplies the paper S to the image forming section 10; an integral user interface 13 that receives an operation input from a user and that presents information to the user; and a principal controller 14 that controls operation of the entire image forming system 100.

The post-processing apparatus 2 is provided with a transport unit 3 that receives the paper S on which an image has been formed from the image forming apparatus 1 and transports the paper S; a folding unit 4 that performs a folding process on the paper S which has been transported from the transport unit 3; a finisher unit 5 that performs a final process on the paper S which has passed through the folding unit 4; and an interposer 6 that supplies a lining board to be used as the cover of a booklet or the like. The post-processing apparatus 2 is further provided with a paper processing controller 7 that controls the various functional sections of the post-processing apparatus 2.

In the exemplary embodiment, the paper processing controller 7 is provided in the post-processing apparatus 2. However, the paper processing controller 7 may be provided in the image forming apparatus 1. Alternatively, the principal controller 14 may be configured to provide the control function of the paper processing controller 7.

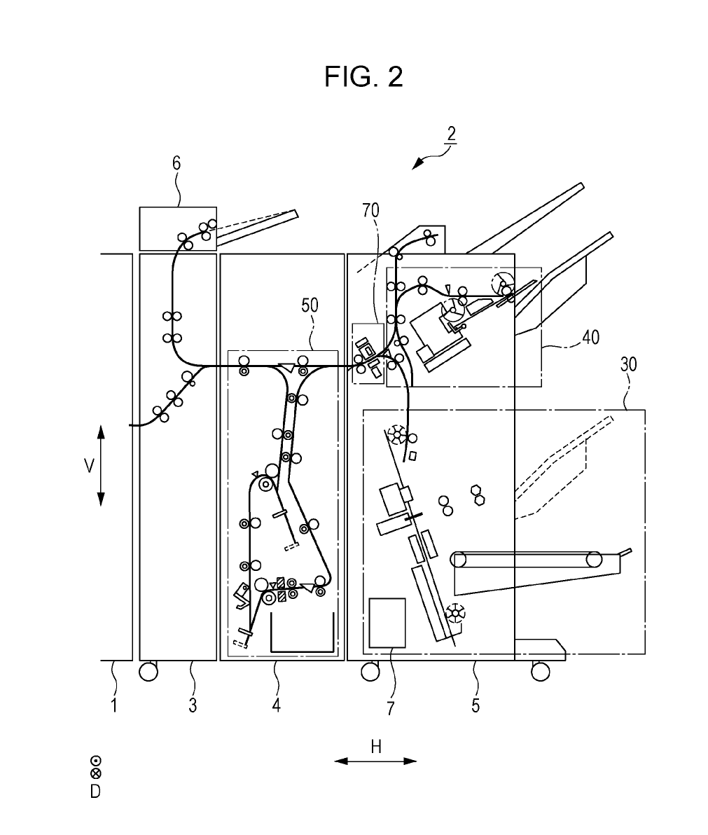

FIG. 2 illustrates the post-processing apparatus 2 according to the exemplary embodiment.

The post-processing apparatus 2 includes the finisher unit 5. The finisher unit 5 includes a punch function section 70 that punches holes, e.g. two holes or four holes, in the paper S. Further, the finisher unit 5 is provided with an end binding function section 40 that stacks a necessary number of pieces of the paper S to generate a paper bundle, and that binds an end portion of the paper bundle using a staple (end binding).

The post-processing apparatus 2 is also provided with a center bookbinding function section 30 that stacks a necessary number of pieces of the paper S to generate a paper bundle, and that binds a center portion of the paper bundle (center binding) to generate a booklet (bookbinding).

In addition, the folding unit 4 of the post-processing apparatus 2 is provided with a folding function section 50 that inwardly folds the paper S in three (C fold), outwardly folds the paper S in three (Z fold), and so forth.

<Configuration of Center Bookbinding Function Section 30>

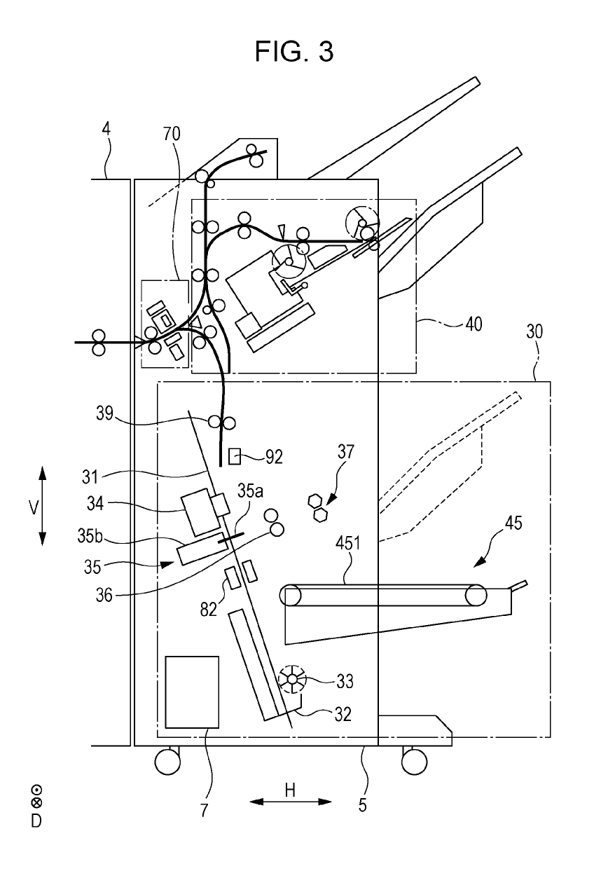

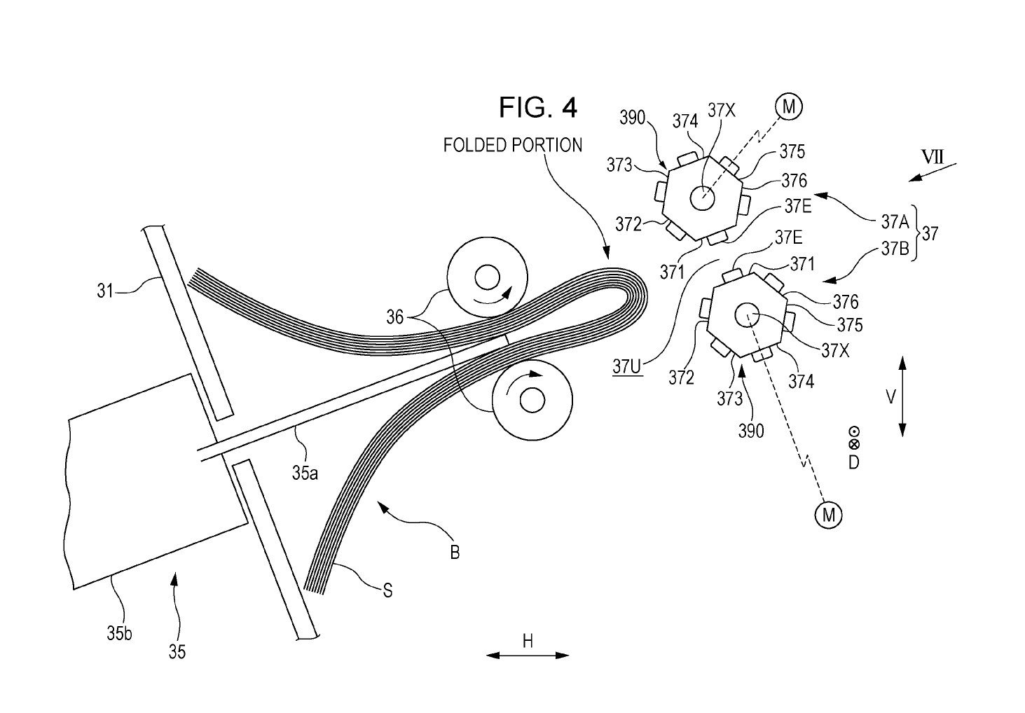

FIG. 3 illustrates the center bookbinding function section 30. FIG. 4 illustrates components around a folding processing mechanism 35.

As illustrated in FIG. 3, the center bookbinding function section 30 is provided with: a compiling member 31 that is formed in a plate shape and that stacks a predetermined number of sheets of the paper S after the image formation to form a paper bundle; carry-in rollers 39 that carry the paper S into the compiling member 31 one sheet at a time; and an end guide 32 that supports the paper bundle on the compiling member 31 from below. The end guide 32 is movable along the compiling member 31.

The center bookbinding function section 30 is also provided with: a paper aligning paddle 33 that urges the sheets of the paper S stacked on the compiling member 31 toward the end guide 32 to align the respective end portions of the sheets of the paper S; and a paper width aligning member 34 that aligns the sheets of the paper S stacked on the compiling member 31 in the width direction. The center bookbinding function section 30 is further provided with a stapler 82 that causes a staple (not illustrated) to penetrate the paper bundle on the compiling member 31 to bind the paper bundle.

The center bookbinding function section 30 is further provided with the folding processing mechanism 35 which folds the paper bundle which has been bound.

The folding processing mechanism 35 includes a folding knife 35a and an advancing mechanism 35b that includes a motor etc. and that advances the folding knife 35a from the back surface side toward the accommodation surface side of the compiling member 31.

The center bookbinding function section 30 is also provided with: nipping rollers 36 that include a pair of rollers that nip the paper bundle that the folding knife 35a has started folding; and a pressing roller portion 37 that presses the folded portion of the paper bundle which has passed through the nipping rollers 36.

The center bookbinding function section 30 is further provided with: a paper placement portion 45 which is provided downstream of the pressing roller portion 37 and on which the paper bundle which has been bound into a booklet is to be placed; and a paper sensor 92 that detects the paper S to be carried into the compiling member 31 by the carry-in rollers 39.

A portion provided with the compiling member 31, the folding processing mechanism 35, and so forth may be considered as a booklet generating apparatus that generates a booklet. Meanwhile, a portion provided with the pressing roller portion 37 may be considered as a booklet processing apparatus that processes a booklet.

As illustrated in FIG. 4, the nipping rollers 36 transport a paper bundle B downstream to position the folded portion of the paper bundle B at a pressing location 37U at which a pressing process is performed by the pressing roller portion 37.

In the exemplary embodiment, the separation distance between the nipping rollers 36 and the pressing roller portion 37 is set to be smaller than the length of the paper bundle B (length in the transport direction).

As illustrated in FIG. 4, the folding processing mechanism 35 is provided with the folding knife 35a and the advancing mechanism 35b which advances the folding knife 35a toward the paper bundle B.

In the exemplary embodiment, when the folding knife 35a is advanced toward the paper bundle B, the distal end of the folding knife 35a reaches the nipping rollers 36. A fold is formed on the paper bundle B when the folding knife 35a is advanced into the paper bundle B. Further, the fold (folded portion) is pressed by the nipping rollers 36 from both sides.

The folding knife 35a is positioned behind the compiling member 31 in the paper stacking stage in which sheets of the paper are stacked on the compiling member 31, the center binding stage performed by the stapler 82 (see FIG. 3), and the paper transporting stage after the center binding. This suppresses interference between the paper S and the folding knife 35a.

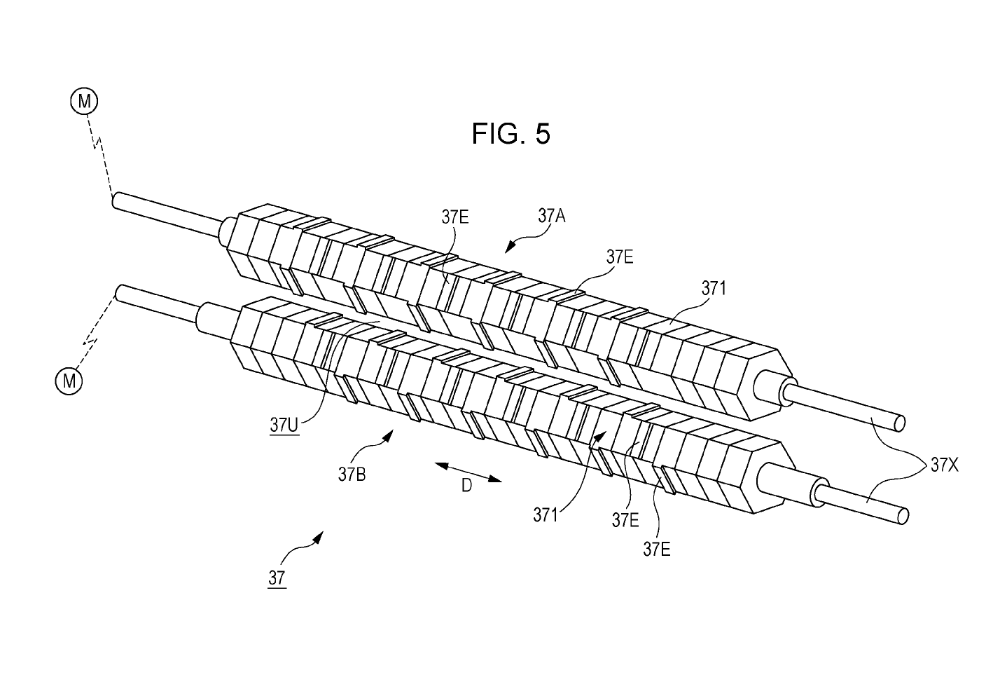

FIG. 5 is a perspective view of the pressing roller portion 37.

The pressing roller portion 37 includes a first pressing roller 37A and a second pressing roller 37B that are a pair of rollers that press the folded portion of the paper bundle (booklet) B.

When the folded portion of the paper bundle B is pressed by the pressing roller portion 37, the first pressing roller 37A which functions as a pressing member is positioned on one surface side of the paper bundle B. Meanwhile, the second pressing roller 37B which functions as an opposite pressing member is positioned opposite to the first pressing roller 37A across the folded portion of the paper bundle B.

In the exemplary embodiment, in addition, each of the first pressing roller 37A and the second pressing roller 37B is provided so as to rotate about a rotary shaft 37X. In the exemplary embodiment, the rotary shaft 37X extends along the front-rear direction D.

The pressing roller portion 37 according to the exemplary embodiment performs: “rotating operation” in which each of the first pressing roller 37A and the second pressing roller 37B is rotated about the rotary shaft 37X; “advancing operation” in which the first pressing roller 37A and the second pressing roller 37B are advanced toward the folded portion of the paper bundle B to press the folded portion; and “retracting operation” in which the first pressing roller 37A and the second pressing roller 37B are retracted from the folded portion.

A mechanism that performs the “rotating operation”, the “advancing operation”, and the “retracting operation” may be constructed using the existing technology. For example, a mechanism that performs the “rotating operation” may include a motor that serves as a drive source and a gear train that connects between the motor and the first pressing roller 37A and the second pressing roller 37B.

Meanwhile, a mechanism that performs the “advancing operation” and the “retracting operation” may include a motor that serves as a drive source, a cam rotated by the motor, and a support member that supports the first pressing roller 37A and the second pressing roller 37B and that is swung by the cam, for example.

In the exemplary embodiment, further, the first pressing roller 37A is formed to have a polygonal cross-sectional shape (cross-sectional shape taken along a plane that intersects (is orthogonal to) the rotary shaft 37X). More specifically, the first pressing roller 37A is formed to have a hexagonal cross-sectional shape

Further, the first pressing roller 37A has opposing surfaces 371 that oppose the folded portion of the paper bundle B. Projecting portions 37E are formed on the opposing surfaces 371.

In addition, the length of the first pressing roller 37A in the axial direction is larger than the length of the folded portion of the paper bundle B. That is, the first pressing roller 37A is formed to extend over the entire folded portion of the paper bundle B. Further, the first pressing roller 37A is provided such that the rotary shaft 37X extends along the folded portion.

In the exemplary embodiment, switching is performed among the opposing surfaces 371 through rotation of the first pressing roller 37A.

More particularly, in the exemplary embodiment, the first pressing roller 37A has a hexagonal cross-sectional shape. Therefore, as illustrated in FIG. 4, the first pressing roller 37A is provided with six opposing surfaces 371 to 376 (hereinafter referred to as “first opposing surface 371 to sixth opposing surface 376”).

In the exemplary embodiment, when the first pressing roller 37A is rotated, the opposing surface which opposes the folded portion of the paper bundle B is changed from one opposing surface included in the six opposing surfaces 371 to 376 to a different opposing surface.

A further description follows. In the exemplary embodiment, as illustrated in FIG. 4, a motor M that rotates the first pressing roller 37A functions as a part of a rotating unit. The motor M rotates the first pressing roller 37A so that the portion of the first pressing roller 37A which confronts the folded portion is changed to a different portion.

The second pressing roller 37B is constructed in the same manner as the first pressing roller 37A.

That is, as illustrated in FIG. 4, the second pressing roller 37B is formed to have a hexagonal cross-sectional shape, and includes six opposing surfaces (first opposing surface 371 to sixth opposing surface 376). Further, projecting portions 37E are formed on each of the six opposing surfaces.

The second pressing roller 37B is disposed below the first pressing roller 37A in the vertical direction V. In addition, the second pressing roller 37B is formed such that the length in the axial direction of the second pressing roller 37B is larger than the length of the folded portion of the paper bundle B. In other words, the second pressing roller 37B is formed to extend over the entire folded portion of the paper bundle B.

In addition, as illustrated in FIG. 5, the second pressing roller 37B is disposed so as to extend along the first pressing roller 37A. The second pressing roller 37B is also rotated about the rotary shaft 37X in the same manner as the first pressing roller 37A. The second pressing roller 37B is rotated in the opposite direction to the first pressing roller 37A.

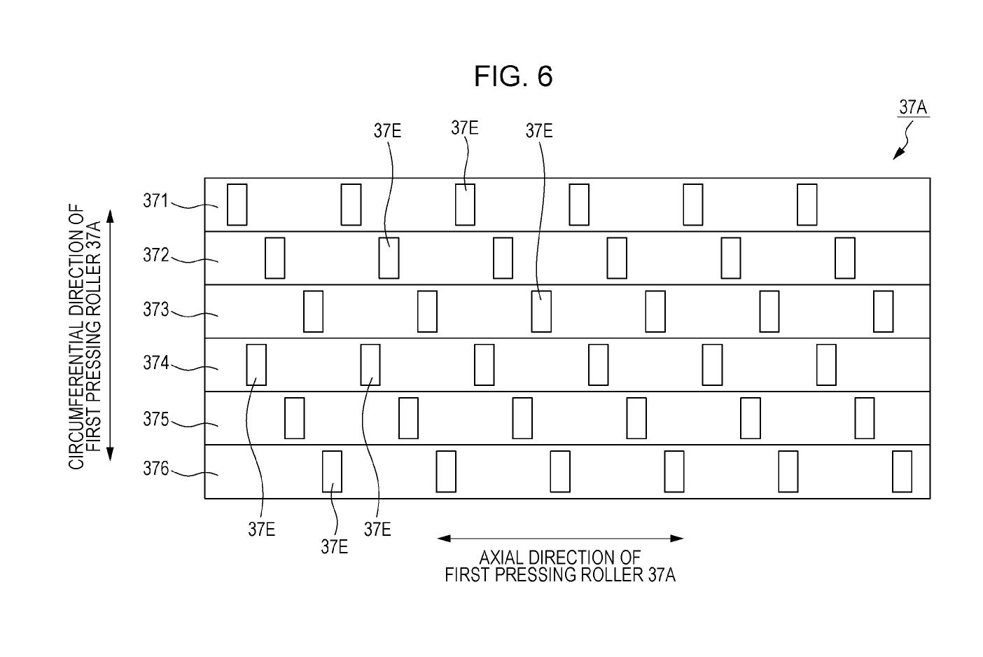

FIG. 6 is a development view of the outer peripheral surface of the first pressing roller 37A. Although the first pressing roller 37A is described here, the second pressing roller 37B is also constructed in the same manner as the first pressing roller 37A.

In the exemplary embodiment, as discussed above, the first opposing surface 371 to the sixth opposing surface 376 are provided. In the development view illustrated in FIG. 6, the first opposing surface 371 to the sixth opposing surface 376 are arranged side by side in the vertical direction.

Each of the first opposing surface 371 to the sixth opposing surface 376 is provided with plural projecting portions 37E. The arrangement positions of the projecting portions 37E in the axial direction of the first pressing roller 37A differ among the opposing surfaces. In the exemplary embodiment, in addition, the projecting portions 37E are provided such that all the projecting portions 37E formed on the first opposing surface 371 to the sixth opposing surface 376 would be arranged side by side with no clearance in the axial direction if the projecting portions 37E were arranged side by side in one line without being displaced in the axial direction.

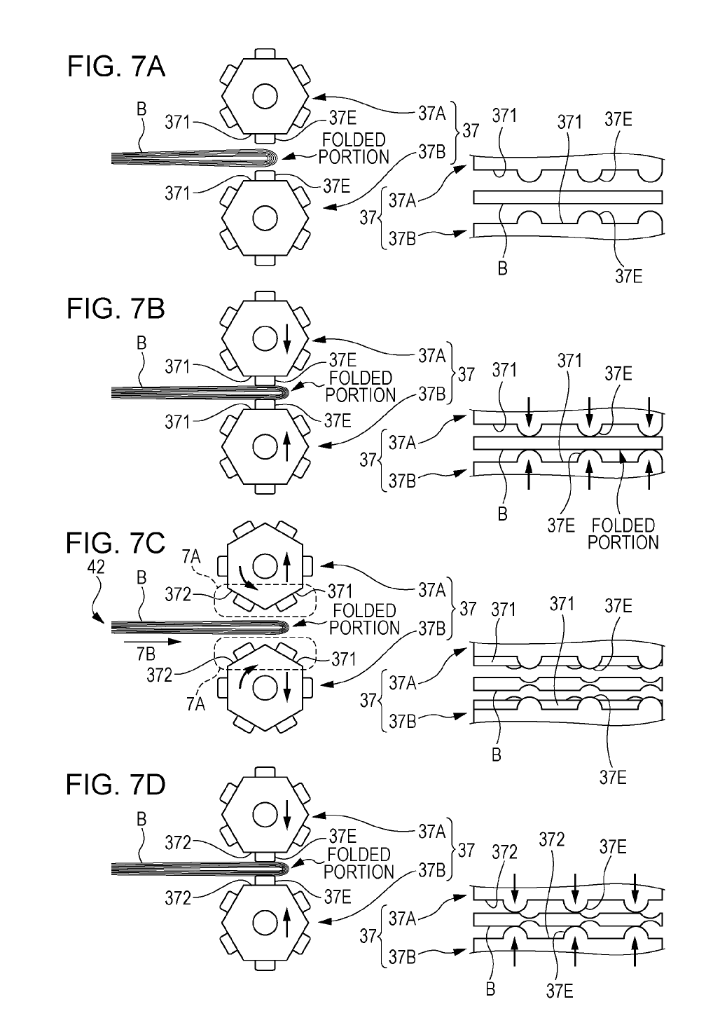

FIGS. 7A to 7D illustrate a pressing process performed by the pressing roller portion 37. Each of FIGS. 7A to 7D also illustrates a state in which the pressing roller portion 37 and the paper bundle B are seen from the direction of the arrow VII in FIG. 4.

In the exemplary embodiment, the paper bundle B is transported to the pressing roller portion 37 by the nipping rollers 36 (see FIG. 3). When the folded portion of the paper bundle B reaches the pressing roller portion 37, the transport of the paper bundle B by the nipping rollers 36 is stopped. At this time, as illustrated in FIG. 7A, the first pressing roller 37A and the second pressing roller 37B are separated from each other in the pressing roller portion 37.

Next, in the exemplary embodiment, as illustrated in FIG. 7B, the first pressing roller 37A and the second pressing roller 37B are advanced toward the folded portion so that the folded portion is pressed by the first pressing roller 37A and the second pressing roller 37B.

More specifically, the folded portion is pressed by the projecting portions 37E provided on the first opposing surface 371 of the first pressing roller 37A and the projecting portions 37E provided on the first opposing surface 371 of the second pressing roller 37B. This reduces the bulge of the paper bundle B at the folded portion.

Then, in the exemplary embodiment, as illustrated in FIG. 7C, the first pressing roller 37A and the second pressing roller 37B are retracted from the folded portion while rotating.

Consequently, the portions (opposing surfaces) of the first pressing roller 37A and the second pressing roller 37B which confront the folded portion are changed to different portions (different opposing surfaces).

In the exemplary embodiment, when the first pressing roller 37A and the second pressing roller 37B are retracted from the folded portion, the first pressing roller 37A and the second pressing roller 37B make one-sixth rotation.

Consequently, the second opposing surface 372 provided to each of the first pressing roller 37A and the second pressing roller 37B confronts the folded portion.

After that, as illustrated in FIG. 7D, the folded portion is pressed again by the first pressing roller 37A and the second pressing roller 37B.

More specifically, the folded portion is pressed by the projecting portions 37E provided on the second opposing surface 372 of the first pressing roller 37A and the projecting portions 37E provided on the second opposing surface 372 of the second pressing roller 37B.

In the exemplary embodiment, as illustrated in FIG. 6, the projecting portions 37E provided on the first opposing surface 371 and the projecting portions 37E provided on the second opposing surface 372 are different in installation position in the axial direction of the first pressing roller 37A and the second pressing roller 37B, and the second opposing surfaces 372 perform pressing at locations that are different from the locations at which pressing is performed by the first opposing surfaces 371.

After that, in the exemplary embodiment, the operation described above is performed repeatedly.

That is, the first pressing roller 37A and the second pressing roller 37B are repeatedly advanced toward and retracted from the folded portion (retracted with the first pressing roller 37A and the second pressing roller 37B rotating).

The rotational direction of the first pressing roller 37A and the second pressing roller 37B will be described.

In the exemplary embodiment, as illustrated in FIG. 7C, when the first pressing roller 37A and the second pressing roller 37B are rotated, the first pressing roller 37A is rotated counterclockwise, and the second pressing roller 37B is rotated clockwise.

In other words, in the exemplary embodiment, the first pressing roller 37A and the second pressing roller 37B are rotated such that the portions of the first pressing roller 37A and the second pressing roller 37B which confront the folded portion (the portions indicated by symbol 7A, which will hereinafter be referred to as “confronting portions 7A”) are moved rightward in FIG. 7C.

A further description follows. When the first pressing roller 37A and the second pressing roller 37B are rotated, the first pressing roller 37A and the second pressing roller 37B are rotated such that the confronting portions 7A are moved downstream in the direction in which the paper bundle B extends.

As illustrated in FIG. 7C, the paper bundle B according to the exemplary embodiment has the folded portion and a foredge portion (open portion) 42 provided opposite to the folded portion.

Further, the paper bundle B according to the exemplary embodiment is flat, and is formed to extend in one direction (the direction indicated by an arrow 7B in FIG. 7C) from the foredge portion 42 toward the folded portion. In the exemplary embodiment, the folded portion is positioned on the downstream side in the one direction.

In the exemplary embodiment, the first pressing roller 37A and the second pressing roller 37B are rotated such that the confronting portions 7A are moved downstream in the one direction.

In the exemplary embodiment, the first pressing roller 37A and the second pressing roller 37B which are rotating (such that the confronting portions 7A are moved in the one direction (the direction indicated by the arrow 7B)) are retracted from the paper bundle B with the first pressing roller 37A and the second pressing roller 37B contacting the paper bundle B.

An additional description follows. Rotation of the first pressing roller 37A and the second pressing roller 37B is not started after the first pressing roller 37A and the second pressing roller 37B are moved away from the paper bundle B, but rotation of the first pressing roller 37A and the second pressing roller 37B is started at the same time as or before retraction of the first pressing roller 37A and the second pressing roller 37B is started.

In the exemplary embodiment, in particular, the first pressing roller 37A and the second pressing roller 37B are formed to have a hexagonal cross-sectional shape, and six corner portions 390 (ridge lines that extend along the rotary shaft 37X) are provided on the surfaces of the first pressing roller 37A and the second pressing roller 37B as illustrated in FIG. 4.

In the exemplary embodiment, when the first pressing roller 37A and the second pressing roller 37B which are rotating contact the paper bundle B, the corner portions 390 are rubbed against the folded portion.

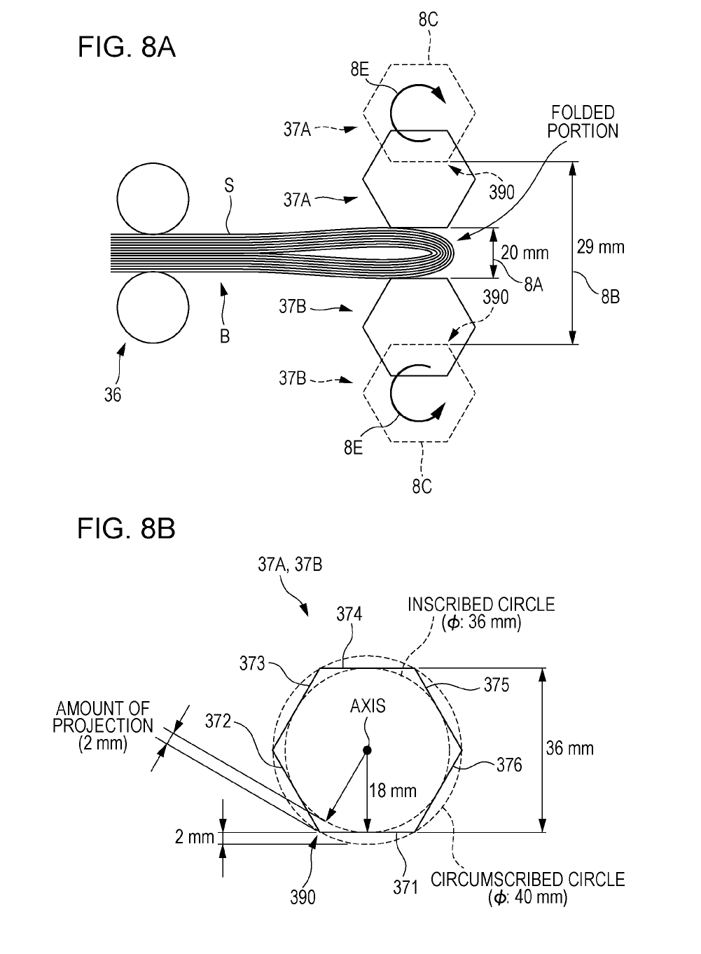

FIGS. 8A and 8B illustrate the details of the first pressing roller 37A and the second pressing roller 37B. The first pressing roller 37A and the second pressing roller 37B will be further described with reference to FIGS. 8A and 8B. In FIGS. 8A and 8B, the projecting portions 37E are not illustrated.

A case where the paper bundle B includes 16 sheets of the paper S and the folded portion has a thickness of 20 mm, for example, is assumed.

As illustrated in FIG. 8B, in addition, the separation distance between two opposing surfaces of the first pressing roller 37A and the second pressing roller 37B that oppose each other across the axis is determined as 36 mm.

In this case, the diameter of a circumscribed circle that circumscribes the body portion (the portion excluding the projecting portions 37E) of the first pressing roller 37A and the second pressing roller 37B is 40 mm. In addition, the diameter of an inscribed circle that inscribes the body portion is 36 mm.

Under such conditions, in order to rotate the first pressing roller 37A and the second pressing roller 37B such that the first pressing roller 37A and the second pressing roller 37B do not contact the paper bundle B (in order to rotate the first pressing roller 37A and the second pressing roller 37B such that the confronting portions 7A are moved in the direction opposite to the one direction, and in order that the paper bundle B will not be bent, it is necessary that the amount of separation between the first pressing roller 37A and the second pressing roller 37B with the first pressing roller 37A and the second pressing roller 37B retracted should be 29 mm, for example, as indicated by symbol 8B in FIG. 8A.

The amount of separation of 29 mm is obtained by the expression 20 mm+(2 mm+2 mm)+5 mm.

“20 mm” corresponds to the thickness of the folded portion of the paper bundle B. In addition, the value of the two terms “2 mm” has been determined in consideration of the corner portions 390 (see FIG. 8A) provided to the first pressing roller 37A and the second pressing roller 37B.

When rotation of the first pressing roller 37A and the second pressing roller 37B (rotation that moves the confronting portions 7A in the opposite direction to the one direction) (rotation in the direction indicated by an arrow 8E) is started from the state indicated by symbol 8C in FIG. 8A, the corner portion 390 of the first pressing roller 37A and the second pressing roller 37B projects toward the folded portion.

In the exemplary embodiment, the amount of projection at this time is 2 mm. A detailed description is made with reference to FIG. 8B. The amount of projection of the corner portion 390 is equal to the distance from the circumference of a circle that inscribes the first pressing roller 37A or the second pressing roller 37B to the vertex of the corner portion 390. In the exemplary embodiment, the distance is 2 mm.

In the exemplary embodiment, the amount of projection, 2 mm (2 mm for each of the first pressing roller 37A and the second pressing roller 37B, which results in a total of 4 mm), is added to the thickness described above, 20 mm. In the example, further, a margin of 5 mm is provided, and added to 20 mm. This results in 29 mm calculated above.

In the case where the first pressing roller 37A and the second pressing roller 37B are rotated such that the confronting portions 7A are moved downstream in the one direction as in the exemplary embodiment, meanwhile, the first pressing roller 37A and the second pressing roller 37B may contact the paper bundle B, and therefore, the amount of separation may be 20 mm (see symbol 8A in FIG. 8A), which is the same as the thickness of the folded portion, for example.

The difference between the amount of separation calculated above, 29 mm, and the amount of separation in the exemplary embodiment, 20 mm, (difference in amount of movement) is 9 mm.

Further, if a case where rotation (one-sixth rotation) of the first pressing roller 37A and the second pressing roller 37B is made five times so that the first opposing surface 371 to the sixth opposing surface 376 sequentially confront the folded portion is assumed, the difference in amount of movement since the start until the end of the pressing of the folded portion is 45 mm (difference of 9 mm multiplied by five times).

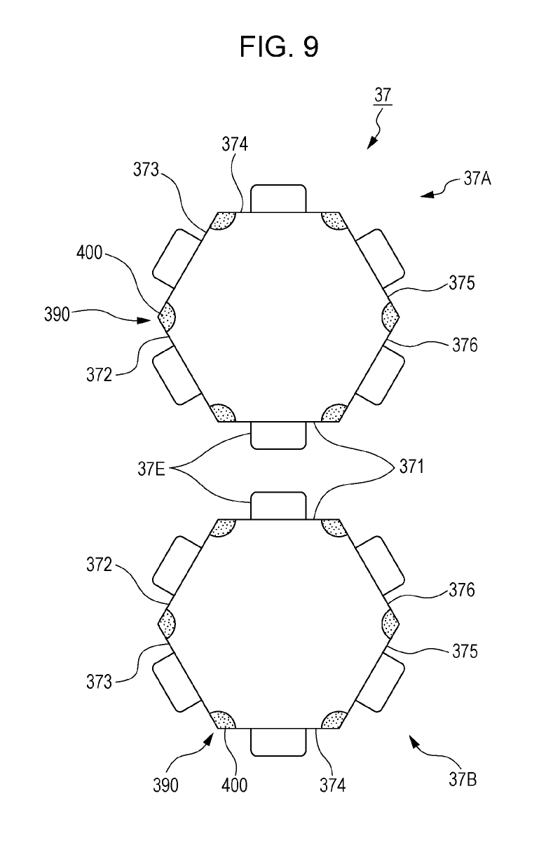

FIG. 9 illustrates another configuration example of the first pressing roller 37A and the second pressing roller 37B.

In the configuration example, rubber members 400 are provided at the six corner portions 390 of the first pressing roller 37A and the six corner portions 390 of the second pressing roller 37B.

The rubber members 400 may be members that are separate from the body portion (the portion excluding the projecting portions 37E) of the first pressing roller 37A and the second pressing roller 37B, and attached to the body portion.

Alternatively, the rubber members 400 may be provided to the body portion of the first pressing roller 37A and the second pressing roller 37B through two-color molding, for example.

Alternatively, the rubber members 400 may be provided not only at the corner portions 390 but also over the entire periphery of the body portion of the first pressing roller 37A and the second pressing roller 37B.

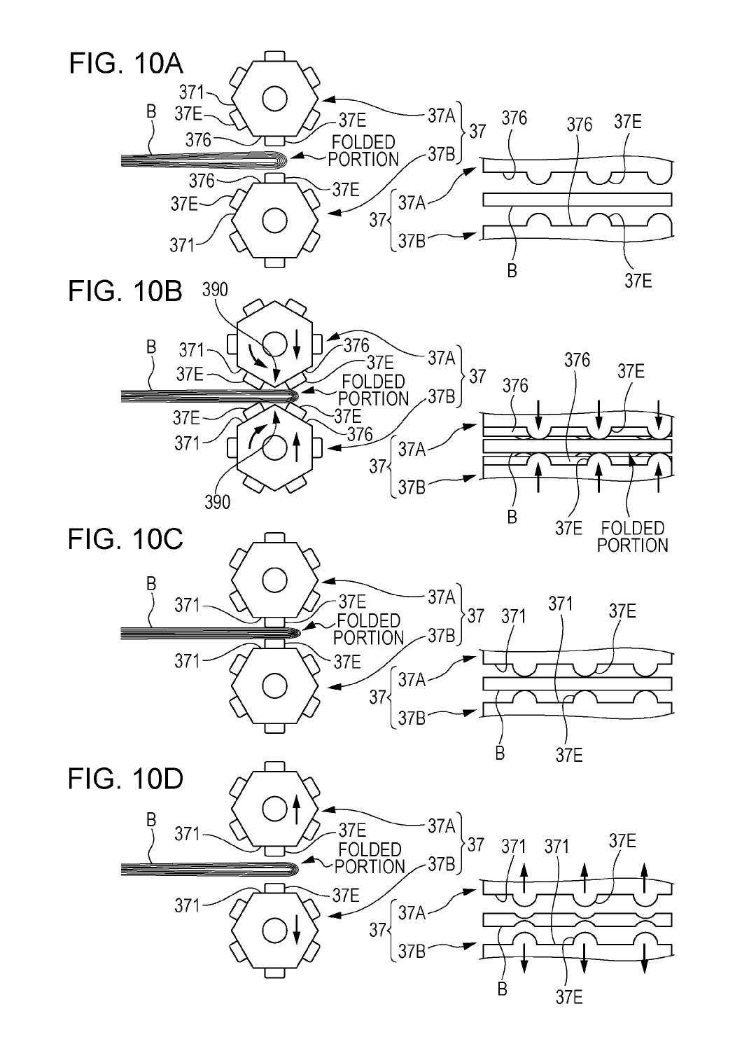

FIGS. 10A to 10D illustrate another operation example of the first pressing roller 37A and the second pressing roller 37B.

In the above description, the first pressing roller 37A and the second pressing roller 37B are rotated when the first pressing roller 37A and the second pressing roller 37B are retracted from the folded portion. However, the first pressing roller 37A and the second pressing roller 37B may be rotated when the first pressing roller 37A and the second pressing roller 37B are advanced toward the folded portion.

A specific description is made with reference to FIGS. 10A to 10D. When the first pressing roller 37A and the second pressing roller 37B are advanced toward the folded portion, the first pressing roller 37A and the second pressing roller 37B are advanced toward the folded portion from the state illustrated in FIG. 10A.

In this event, as illustrated in FIG. 10B, the first pressing roller 37A and the second pressing roller 37B are advanced while being rotated.

Also in this case, in the same manner as described above, the first pressing roller 37A is rotated counterclockwise, and the second pressing roller 37B is rotated clockwise.

When the first pressing roller 37A and the second pressing roller 37B are advanced toward the folded portion, in addition, as illustrated in FIG. 10B, the corner portions 390 of the first pressing roller 37A and the second pressing roller 37B are caused to contact the folded portion of the paper bundle B to level the paper bundle B.

When the advancement of the first pressing roller 37A and the second pressing roller 37B is completed, the state illustrated in FIG. 10C is achieved, and the folded portion of the paper bundle B is pressed by the first pressing roller 37A and the second pressing roller 37B.

After that, in the exemplary embodiment, as illustrated in FIG. 10D, the first pressing roller 37A and the second pressing roller 37B are retracted from the folded portion of the paper bundle B. In this event, the first pressing roller 37A and the second pressing roller 37B are not rotated.

After that, the operation described above is repeatedly performed. That is, the first pressing roller 37A and the second pressing roller 37B are advanced toward the folded portion, with the first pressing roller 37A and the second pressing roller 37B rotating, and retracted from the folded portion repeatedly.

Alternatively, the first pressing roller 37A and the second pressing roller 37B may be rotated at two timings, when the first pressing roller 37A and the second pressing roller 37B are retracted from the folded portion and when the first pressing roller 37A and the second pressing roller 37B are advanced toward the folded portion.

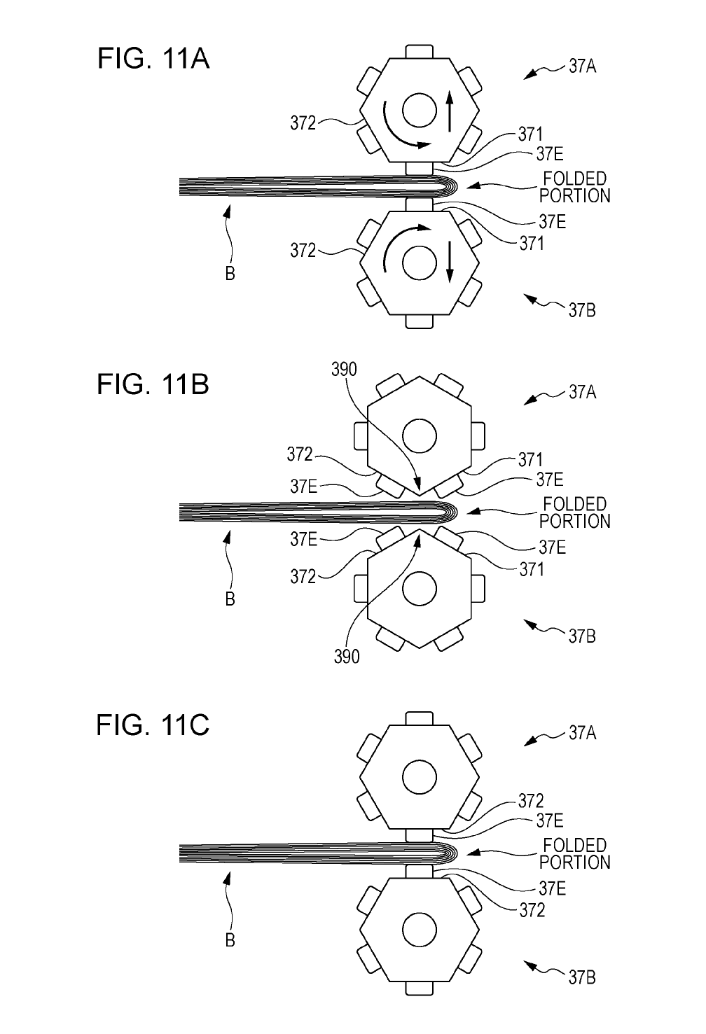

FIGS. 11A to 11C illustrate operation of the first pressing roller 37A and the second pressing roller 37B in the case where the first pressing roller 37A and the second pressing roller 37B are rotated when the pressing rollers are retracted from and advanced toward the folded portion.

When the first pressing roller 37A and the second pressing roller 37B are retracted from the folded portion, the first pressing roller 37A and the second pressing roller 37B are retracted while being rotated from the state illustrated in FIG. 11A. When the retraction is completed, the first pressing roller 37A and the second pressing roller 37B are in the state illustrated in FIG. 11B.

When the first pressing roller 37A and the second pressing roller 37B are retracted, the first pressing roller 37A and the second pressing roller 37B make one-twelfth rotation. Therefore, when the retraction of the first pressing roller 37A and the second pressing roller 37B is completed, the corner portions 390 of the first pressing roller 37A and the second pressing roller 37B confront the folded portion as illustrated in FIG. 11B.

After that, in the exemplary embodiment, the first pressing roller 37A and the second pressing roller 37B are advanced toward the folded portion from the state illustrated in FIG. 11B. Also during the advancement, in the same manner as described above, the first pressing roller 37A and the second pressing roller 37B are advanced while being rotated. When the advancement of the first pressing roller 37A and the second pressing roller 37B is completed, the first pressing roller 37A and the second pressing roller 37B are in the state illustrated in FIG. 11C.

Also during the advancement, in the same manner as during the retraction, the first pressing roller 37A and the second pressing roller 37B make one-twelfth rotation.

In the example illustrated in FIGS. 7A to 7D, the first pressing roller 37A and the second pressing roller 37B are caused to make one-sixth rotation when the first pressing roller 37A and the second pressing roller 37B are retracted, and the first pressing roller 37A and the second pressing roller 37B are advanced after the end of the one-sixth rotation when the advancement of the first pressing roller 37A and the second pressing roller 37B is started.

Next, the amount of separation between the first pressing roller 37A and the second pressing roller 37B will be described.

In the exemplary embodiment, when the paper bundle B is received between the first pressing roller 37A and the second pressing roller 37B, the first pressing roller 37A and the second pressing roller 37B are separated from each other. The amount of separation between the first pressing roller 37A and the second pressing roller 37B may be a constant value.

The amount of separation may differ in accordance with the thickness of the folded portion of the paper bundle B, for example, rather than being constant. Specifically, the amount of separation between the first pressing roller 37A and the second pressing roller 37B at the time when the folded portion of the paper bundle B is received between the first pressing roller 37A and the second pressing roller 37B (hereinafter referred to as a “reception-time separation amount”) may differ in accordance with the thickness of the folded portion.

More specifically, the reception-time separation amount is made smaller in the case where the thickness of the folded portion is smaller than a predetermined thickness than in the case where the thickness of the folded portion is larger than the predetermined thickness.

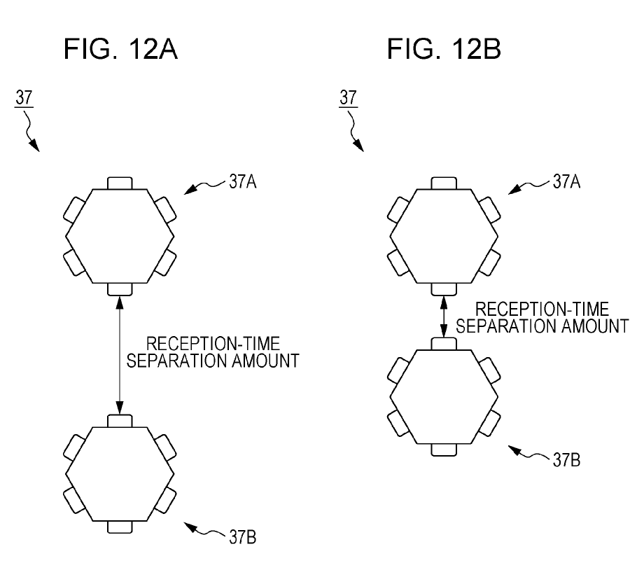

FIGS. 12A and 12B illustrate the reception-time separation amount.

FIG. 12A illustrates the reception-time separation amount at the time when a pressing process is performed on the folded portion of the paper bundle B which includes 20 sheets of the paper S of A3 size. FIG. 12B illustrates the reception-time separation amount at the time when a pressing process is performed on the folded portion of the paper bundle B which includes 5 sheets of the paper S of A4 size. In the exemplary embodiment, the reception-time separation amount is made larger when the number of sheets of the paper S is larger and the thickness of the folded portion is larger.

A further description follows. In the exemplary embodiment, the reception-time separation amount is caused to differ in accordance with the thickness of the folded portion. The reception-time separation amount is made larger as the thickness of the folded portion is larger, and the reception-time separation amount is made smaller as the thickness of the folded portion is smaller.

A further description follows. In the exemplary embodiment, a threshold for the thickness of the folded portion has been set in advance. The reception-time separation amount is made smaller in the case where the thickness of the folded portion is smaller than a predetermined thickness than in the case where the thickness of the folded portion is larger than the predetermined thickness.

In the exemplary embodiment, information such as the number of sheets, the size, and the basis weight of the paper S constituting the paper bundle B is acquired, and the reception-time separation amount is determined on the basis of the information.

Specifically, the paper processing controller 7 (see FIG. 1) first acquires, from the principal controller 14 provided to the image forming apparatus 1, information on the paper S (paper bundle B) to be subjected to the pressing process.

Specifically, the paper processing controller 7 acquires information such as the number of sheets, the size, and the basis weight of the paper S constituting the paper bundle B. In the exemplary embodiment, the principal controller 14 acquires information such as the number of sheets, the size, and the basis weight of the paper S on the basis of job information obtained from the user. Then, such information is transmitted to the paper processing controller 7 via a communication line (not illustrated). Consequently, the paper processing controller 7 obtains information on the paper S (paper bundle B). Then, the paper processing controller 7 determines the reception-time separation amount on the basis of the acquired information.

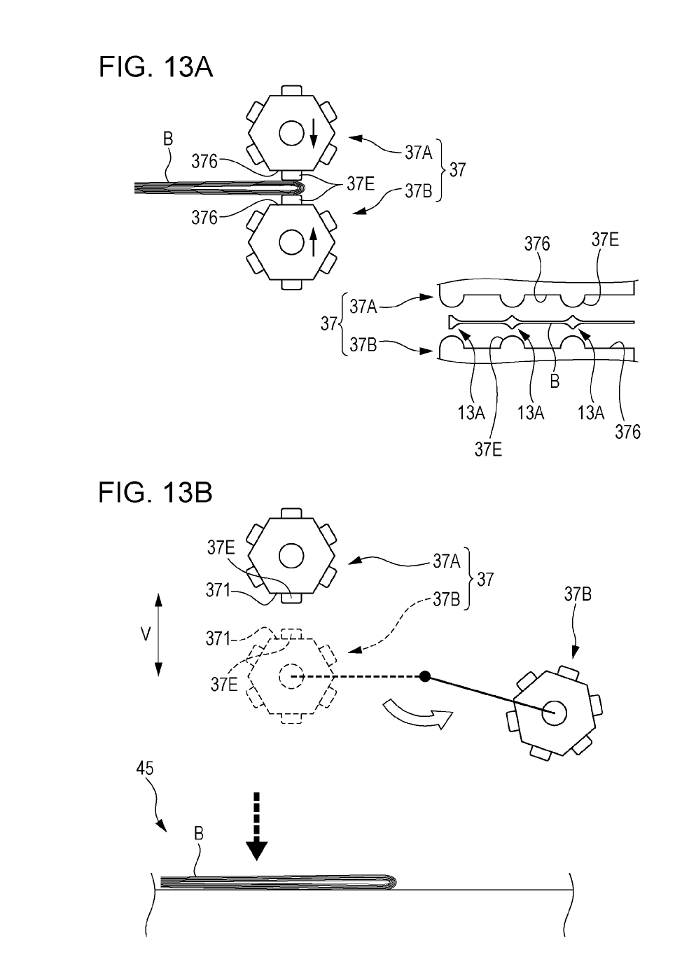

FIGS. 13A and 13B illustrate the final stage of the pressing process performed by the first pressing roller 37A and the second pressing roller 37B.

In the final stage of the pressing process, as illustrated in FIG. 13A, the folded portion is pressed by the sixth opposing surfaces 376. In the pressing performed by (the projecting portions 37E provided on) the sixth opposing surfaces 376, portions indicated by symbol 13A in FIG. 13A are pressed so that the entire region of the folded portion in the longitudinal direction has been subjected to the pressing process.

After that, in the exemplary embodiment, as illustrated in FIG. 13B, the second pressing roller 37B is moved with respect to the first pressing roller 37A. Specifically, the second pressing roller 37B is moved so as to release the lower side of the paper bundle B. In this way, the second pressing roller 37B is moved to a position at which the second pressing roller 37B does not obstruct the transport of the paper bundle B after pressing the folded portion of the paper bundle B. In this case, the paper bundle B falls down by its own weight to be placed on the paper placement portion 45.

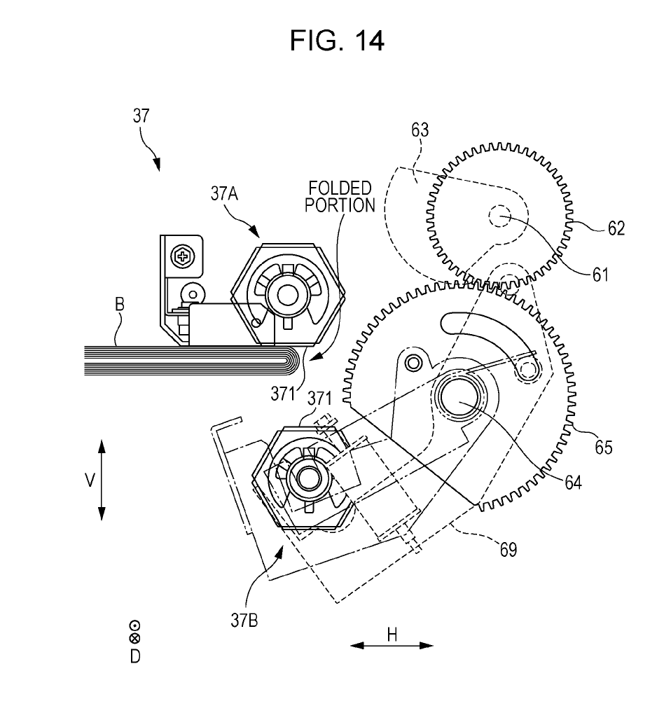

FIG. 14 illustrates a configuration example of a mechanism that advances and retracts the second pressing roller 37B toward and from the folded portion.

In the configuration described above, the two pressing rollers, namely the first pressing roller 37A and the second pressing roller 37B, are advanced toward and retracted from the folded portion. However, only one of the pressing rollers may be advanced and retracted. In the configuration example illustrated in FIG. 14, only the second pressing roller 37B is advanced toward and retracted from the folded portion.

The configuration example is provided with a first gear 62 that is rotationally driven by a motor (not illustrated), a second gear 65 that receives a drive force from the first gear 62 to be rotationally driven, and a swing arm 69 attached to a rotary shaft 64 of the second gear 65. The second pressing roller 37B is supported by the swing arm 69. Further, a cam 63 is attached to a rotary shaft 61 of the first gear 62.

The advancement and retraction of the second pressing roller 37B toward and from the folded portion is performed by driving the motor to rotate the first gear 62 (forward). When the first gear 62 is rotated, the second gear 65 and the rotary shaft 64 are rotated, and the rotary shaft 64 is rotated to rotate the swing arm 69 clockwise in FIG. 14 about the rotary shaft 64. Consequently, the second pressing roller 37B is advanced toward the folded portion. The second pressing roller 37B is retracted from the folded portion by rotating the first gear 62 in reverse.

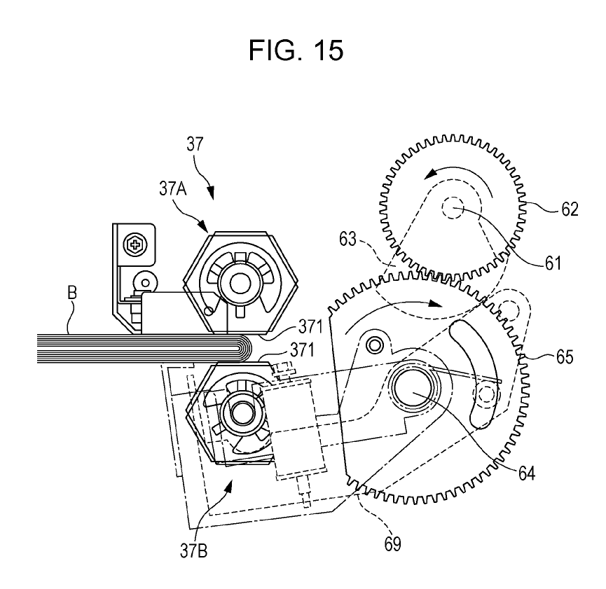

FIG. 15 illustrates a state in which the second pressing roller 37B has been advanced toward the folded portion after the first gear 62 is rotated forward for a predetermined time or more. In the exemplary embodiment, when the amount of rotation of the first gear 62 reaches a predetermined amount of rotation, the cam 63 contacts the swing arm 69 to press the swing arm 69 as illustrated in FIG. 15. As a result, in the exemplary embodiment, the swing arm 69 is further rotated so that the second pressing roller 37B is strongly pressed against the folded portion.

(Others) In the configuration described above, two pressing rollers, namely the first pressing roller 37A and the second pressing roller 37B, are provided. However, it is not necessary to provide two pressing rollers, and one of the two pressing rollers may be replaced with a support stand, for example, that is not rotated or advanced or retracted.

In the configuration described above, the first pressing roller 37A and the second pressing roller 37B are arranged side by side in the vertical direction, and the paper bundle B is transported in the horizontal direction to be supplied to the pressing roller portion 37. However, the first pressing roller 37A and the second pressing roller 37B may be arranged side by side in the horizontal direction, and the paper bundle B may be transported in the vertical direction to be supplied to the pressing roller portion 37.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A booklet processing apparatus comprising:
a pressing member that presses a folded portion of a booklet, the booklet being formed to extend in one direction and having the folded portion on a downstream side in the one direction, the pressing member being provided so as to be rotatable about a rotary shaft that extends along the folded portion; and
a rotating unit that rotates the pressing member so as to move a portion of the pressing member that confronts the folded portion downstream in the one direction so that the portion of the pressing member that confronts the folded portion is changed to a different portion.

2. The booklet processing apparatus according to claim 1,
wherein the pressing member is formed to have a polygonal cross-sectional shape in a plane that intersects the rotary shaft.

3. The booklet processing apparatus according to claim 1,
wherein the pressing member is formed to have a polygonal cross-sectional shape in a plane that intersects the rotary shaft, and has a plurality of ridge lines that extend along a direction in which the rotary shaft extends, and
a rubber member is provided at locations on a surface of the pressing member at which the ridge lines are provided.

4. The booklet processing apparatus according to claim 1,
wherein the booklet processing apparatus is further provided with an opposite pressing member disposed opposite to the pressing member across the folded portion, the pressing member and the opposite pressing member pressing the folded portion, and
an amount of separation between the pressing member and the opposite pressing member at a time when the folded portion is received between the pressing member and the opposite pressing member differs in accordance with a thickness of the folded portion, the amount of separation being smaller in a case where the thickness of the folded portion is smaller than a predetermined thickness than in a case where the thickness of the folded portion is larger than the predetermined thickness.

5. The booklet processing apparatus according to claim 1,
wherein the pressing member is advanced toward the folded portion to press the folded portion, and retracted from the folded portion after pressing the folded portion, and
the rotating unit rotates the pressing member when the pressing member is retracted from the folded portion.

6. The booklet processing apparatus according to claim 1,
wherein the pressing member is advanced toward the folded portion to press the folded portion, and retracted from the folded portion after pressing the folded portion, and
the rotating unit rotates the pressing member when the pressing member is advanced toward the folded portion.

7. The booklet processing apparatus according to claim 1,
wherein the pressing member is advanced toward the folded portion to press the folded portion, and retracted from the folded portion after pressing the folded portion, and
the rotating unit rotates the pressing member when the pressing member is retracted from the folded portion and when the pressing member which has been retracted is advanced toward the folded portion so that the portion that confronts the folded portion is changed to the different portion.

8. An image forming system comprising:
an image forming apparatus that forms an image on paper;
a booklet generating apparatus that generates a booklet from a plurality of sheets of the paper on which the image has been formed by the image forming apparatus; and
a booklet processing apparatus that presses a folded portion of the booklet generated by the booklet generating apparatus,
wherein the booklet processing apparatus is the booklet processing apparatus according to claim 1.
